(19) United States
(12) Patent Application Publication
(10) Pub. No.: US 2006/0249865 A1
(43) Pub. Date: Nov. 9, 2006

(54) In-line lens manufacturing

(76) Inventor: Russell F. Weymouth Jr., Charlton, MA (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 10/571,491

(22) PCT Filed: May 5, 2004
(86) PCT No.: PCT/US04/13846

§ 371 Date: Mar. 9, 2006

Related U.S. Application Data
(63) Continuation of application No. 10/430,035, filed on May 6, 2003, now abandoned.

(51) Int. Cl. B29D 11/00; B29C 37/02

(52) U.S. Cl. 264/2.6; 264/129; 264/135; 264/161

(57) ABSTRACT

Methods are disclosed which decrease the time between de-molding a lens and initiating a hard coating process. The de-molded lens at a de-mold temperature T_{M} is transported away from a mold. A dip tank is maintained at a temperature T_{D}, where T_{D} is less than T_{M}, wherein the dip tank includes a liquid including a primer or a hard coat solution. The lens is dipped into the dip tank wherein the lens has a temperature T_{L} greater than T_{D}, so that intermediate cooling, cleaning, destaticizing and delays associated therewith are avoided. Other methods eliminate many conventional process steps and may include drying raw material to decrease primer coating times and employing robotic systems for carrying out the methods.

### BACKGROUND OF THE INVENTION

1. Field of the Invention

The present invention relates to lens manufacturing and more particularly to systems and methods for dipping lenses for a high yield automated process.

2. Description of the Related Art

Prescription lenses require customization for individual users. Traditionally, prescription lenses were ground from glass based on the prescription and the facial dimensions of the wearer. This is often a time consuming and labor intensive process, which increases costs. In addition, glass can crack or shatter making it difficult to maintain and even creating the possibility for injury.

With improvements in plastics molding, lenses began being fabricated by processes, such as injection molding and compression molding. Plastic materials, such as polycarbonate, provide a plurality of advantages over glass lenses. Molding processes are typically automated and are rapidly performed. In addition, polycarbonate is lighter in weight than glass and does not shatter.

One disadvantage of employing plastic lenses is that plastic is soft compared to glass and, as such, is not sufficiently resistant to scratching. This problem is addressed by coating the lens with a hard coating layer using a process commonly referred to as dipcoating. Conventional dipcoating processes typically require a plurality of cleaning steps after the lens is cooled to room temperature. For example, after cooling the lens from the mold, the lens is dipped in one or more solvent baths followed by detergent baths to ensure the removal of oils and dirt. Cooling the lens to room temperature is required to prevent solvents and detergents from attacking the lens material. Solvents are more likely to cause damage to the lens at elevated temperatures. Lenses are often air cooled, which makes the lens vulnerable to dirt or dust accumulation on the lens. This is increased by static charge which can build up on the lens. One prior art technique employs an alcohol bath to cool and destaticize the lens. However, this process uses alcohol which must then be air dried to permit the alcohol to evaporate. The evaporation time gives air borne particles a chance to collect on the lens. Additionally, although very volatile, alcohol residue may remain on the lens after it has dried, and may require an additional cleaning step or steps.

After being cooled to room temperature either in air or in liquid, the lenses are detergent dipped which is followed by one or more additional solvent (rinse) bath dips. The lens is then dried over a period of time in a filtered environment, which attempts to eliminate particles from the ambient environment. When completely dried, the lenses are initiated into the dip coating process. The dipcoat, once cured, provides scratch resistance for the lens.

The conventional dipcoating process yields a high number of lenses, but is complex and often requires a large number of process steps, some of which are long in duration. Drying times and cleaning stations sometimes become bottlenecks to an assembly line, but are needed since solvent streaks are one of the most common causes of rejecting lenses. In addition, conventional processes require that the lens be cooled, usually to room temperature, prior to the onset of the dipcoating process. This is typically regarded as necessary for promoting adhesion between the hard coat material and the lens and in preventing solvent attack of the lens material.

Referring to FIG. 1, two prior art dip coating techniques are comparatively shown. Lines drawn between states in FIG. 1 approximate each process. Although lines are employed, the lines are used to represent any relationship, e.g., exponential decay or polynumeric relationships, between states. Processes 5 and 7 each represent steps taken after demolding of a lens. The lens has an initial demold temperature indicated as demold temperature 4.

A first process 5 includes a conventional air cool process 5a. After removal from a mold, the lens is cooled to room temperature in an ambient air environment. Once room temperature is achieved, the lens is rinsed 5b, preferably in alcohol and air-dried at 5c. Next, the air-dried lens is dip coated at point 6 and finally cured.

A second process 7 includes a conventional liquid cool process 7a. This process is disclosed in U.S. Pat. No. 6,024,902 to Maus et al. After removal from a mold, the lens is destaticized and cooled to room temperature in an alcohol bath. Once room temperature is achieved, the lens is air-dried 7b for a period and may require a cleaning process (7c) with an additional air dry step (7d). Next, the air-dried lens is dip coated at point 8 and finally cured. As a result of static charge build-up on the lenses, particulate matter is attracted to the lens especially during air-drying. Referring to FIG. 2, static charge on the lenses is reduced by dipping the lenses in one or more baths. FIG. 2 comparatively shows static charge in the lenses during processes 5 and 7. Particulate matter, such as dust, or other air-borne particles, may be deposited on the lens when exposed to air. Although filtered air systems may be employed, particulate matter is still a threat to lenses exposed to air.

Therefore a need exists for an automated lens dipcoating process, which eliminates or significantly reduces drying times in air during the process. A further need exists for reducing the amount of exposure time to particulate matter in air especially when a static charge is present on a lens.

### SUMMARY OF THE INVENTION

A method of decreasing the time between de-molding a lens and initiating a hard coating process, in accordance with the present invention, includes the steps of transporting the de-molded lens at a de-mold temperature T_{M} away from a mold, maintaining a dip tank to a temperature T_{D}, where T_{D} is less than T_{M}, wherein the dip tank includes a liquid including one of a primer and a hard coat solution, and dipping the lens into the dip tank wherein the lens has a temperature T_{L} greater than T_{D}, so that intermediate cooling, cleaning, destaticizing and delays associated therewith are avoided.

A method of decreasing the time for dipcoating a lens, in accordance with the present invention includes the steps of drying thermoplastic raw material in advance of molding an article, molding the article, and dipping the article while the article is at a temperature greater than the ambient temperature in a dip tank including a primer solution, wherein the primer in the solution has a concentration of less than 10% by volume.

Other methods eliminate many conventional process steps and may include drying raw material to decrease primer coating times and employing robotic systems for carrying out the methods. The illustrative embodiments of the present invention should not be construed as limiting the present invention as presented in the appended claims.

### BRIEF DESCRIPTION OF THE DRAWINGS

The advantages, nature, and various additional features of the invention will appear more fully upon consideration of the illustrative embodiments now to be described in detail in connection with accompanying drawings. In the drawings wherein like reference numerals denote similar components throughout the views:

FIG. 1 is a graph comparing temperature vs. time for two prior art preparation processes before dip coating lenses for in-line manufacturing of prescription lenses in accordance with the prior art.

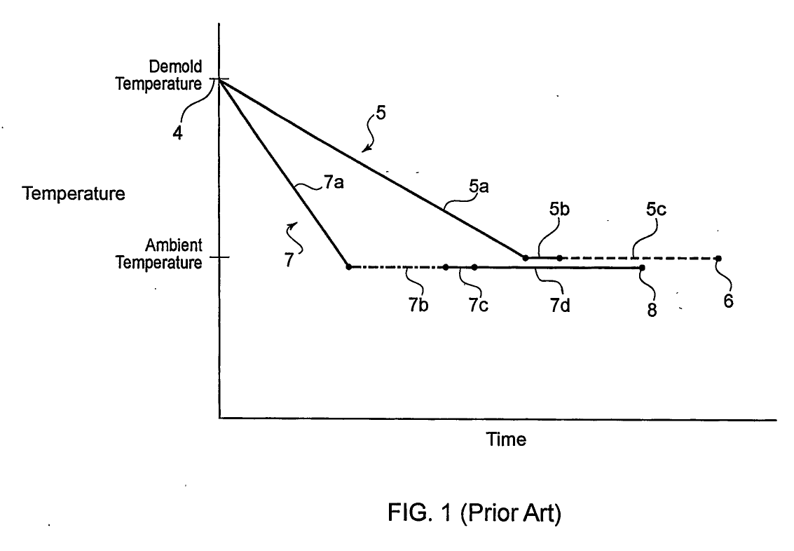

FIG. 2 is a graph comparing static charge vs. time for two prior art preparation processes before dip coating lenses for in-line manufacturing of prescription lenses in accordance with the prior art.

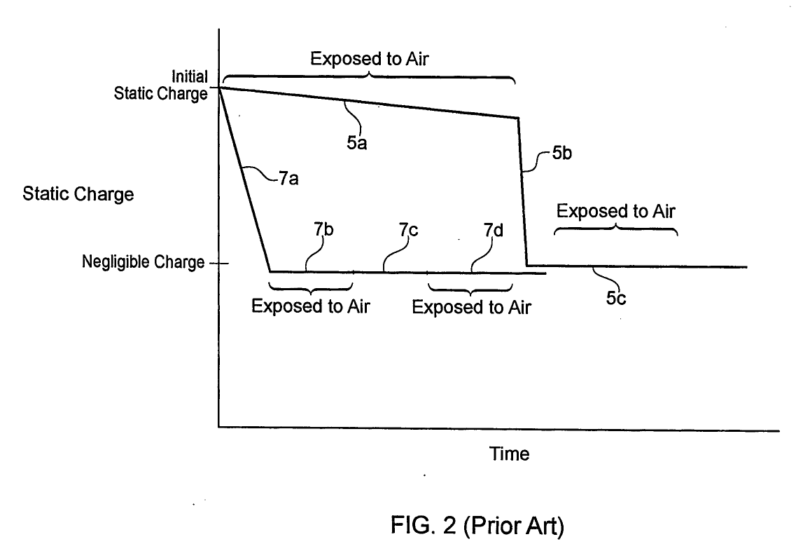

FIG. 3 is a flow chart of steps for dipcoating a lens.

FIGS. 4A and 4B show lens configurations after molding in accordance with one aspect of the present invention.

FIG. 5 is a chart comparing dip coating process start times for the two prior art processes shown in FIGS. 1 and 2 and the process in accordance with the present invention.

FIG. 6 is a schematic diagram showing a system for in-line manufacturing of prescription lenses in accordance with the present invention.

### DETAILED DESCRIPTION OF PREFERRED EMBODIMENTS

The present invention provides methods for dipcoating lenses in an efficient manner, which eliminate or reduce process steps and reduce yield loss due to long duration air drying or air cooling steps. In one embodiment of the present invention, systems and methods advantageously employ an automated robotic system to remove plastic lenses from an injection or compression mold and transfer the lenses to dipping stations. The lens is optionally dipped in a primer solution. Next, the lens is rinsed in a solvent solution and then dipcoated. The method includes transferring the lenses from the mold to dipping stations, and dipping the lens in a primer solution while the lens is still hot. The dipping into the primer solution destaticizes the lens and reduces its temperature. Next, while the lens is still hot, the lens is transported to a rinsing station where it is dipped without drying the lens. The lens is then removed from the rinse bath, subjected to a forced air jet and dipped into a dip coating solution. Advantageously, the lens is not exposed to ambient air between the demold step and the dip coat step for more than a few minutes, and preferably less than 5 minutes. This significantly reduces the risk of particulate deposition on the lens.

Contrary to the prior art, the lens is dipped and processed while it is hot. The molding material employed in the process is preferably subjected to a drying process before being used in the mold. In accordance with the present invention, by reducing the moisture in the raw material before molding, solvent attack on the lens material is minimized. Advantageously, the lens can be processed hot, thereby reducing air cool and air dry times significantly and/or eliminating air cool or air dry times completely from the process.

It is to be understood that the parameters, such as dipping speeds and temperatures may be adjusted or arbitrarily set in accordance with different aspects and applications of the present invention. It is further to be understood that process steps as set forth in the FIGs. may be performed by robots programmed by software or performed directly by software, hardware or a combination therefore. Software programs may be carried out on a processor or processors, including memory and appropriate interfaces for performing system functions and method steps in accordance with the present invention.

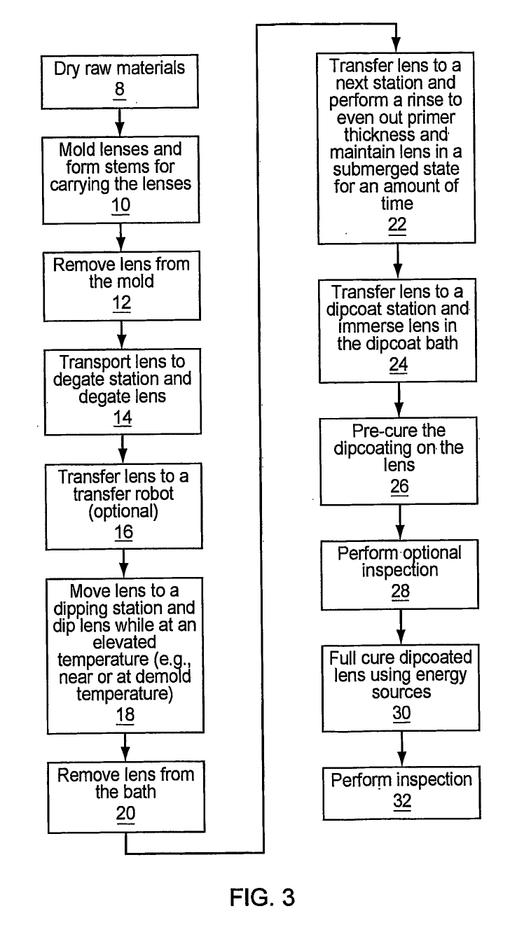

Referring now in specific detail to the drawings in which like reference numerals identify similar or identical elements throughout the several views, and initially to FIG. 3, a flow/block diagram for a method for dipcoating a lens is illustratively shown. In block 8, a drying step is performed on virgin molding materials. Molding materials preferably include polycarbonate although other suitable thermoplastics may be employed. Drying may be performed immediately prior to placing the thermoplastic into a hopper or feed to the molding process (block 10) or drying may be performed at an earlier time and the thermoplastic hermetically sealed to prevent moisture from being absorbed in the thermoplastic. In one particularly useful embodiment, raw material, such as pellets of polycarbonate, are dried by exposing the material to an environment with a dew point temperature of −40 degrees F. or less for about 2-4 hours. Other drying methods, dew point temperatures and drying times may also be used.

It is preferable that moisture present in the thermoplastic material be reduced as much as possible. Thermoplastics, such as polycarbonate can absorb enough moisture to impact its processing in as little as a few minutes. A correlation between drying the raw material and the bonding effectiveness of a primer material to plastic lenses has been determined. Drying (or pre-drying) in block 8 is therefore preferable especially when high throughput dipping is desired. High throughput is provided, among other things, by reduced dipping dwell times, by providing the capability of dipping hot lenses, by eliminating drying steps required by the prior art, etc.

In block 10, a molding process is performed to form a lens, a pair of lenses or multiple pairs of lenses. The molding process may include a plastic molding process, such as an injection or compression molding process, and form stems or other features, which may be employed to hold and transport the lenses. In block 12, the lenses (or lens) are removed from the mold. This may be performed in a plurality of different ways. One skilled in the art would understand that pushpins or pneumatic drivers may be employed to remove a lens along with sprues and/or gated materials from the mold. The molding process is preferably an automated molding process, which includes, for example, a pneumatically or hydraulically actuated split half mold system. A mold temperature/lens temperature at the time of de-molding may be about, e.g., 250 F to about 300 F. A de-mold temperature T_{M} begins to drop after de-molding.

In block 14, a take-out robot removes the molded lens from the molding system and transports the lens to a degate station, if needed. At the degate station, the sprues and/or gated materials are removed from the lens with high efficiency particulate arresting (HEPA) downdraft to controlleliminate dust due to the cutting/degate process. The degate may be performed by employing cutters, such as pneumatic cutters. Degating may not be needed since molds and molding processes are contemplated which produce ready-for-dipping lens structures. These structures may include gated materials; yet need not be degated until later in the process. Cold-runners disposed between two or more lenses may be cut/degated by cutters. The cutters are preferably maintained in an environment that employs a high efficiency particulate arresting (HEPA) air curtain or downdraft airflow to reduce air borne particles, which may be generated, by the cutters or be present in the enclosure.

The transport of the lens preferably occurs in a reduced humidity environment, e.g., 15% relative humidity or less. The reduced humidity environment is preferably heated and maintained in a temperature range from about 90 degrees F. to about 110 degrees F. The environment preferably includes a high efficiency particulate arresting (HEPA) filtered environment.

In block 16, a take-out robot preferably transfers the lens or lenses to a transfer robot. A single robot may perform both take-out and transfer tasks. Alternately, a worker or technician may transfer the lens from the mold to the transfer robot. The transfer robot then orients the lens into a dipping position. This is preferably in a vertical orientation, that is, the major plane of the lens is held in a substantially parallel orientation relative to the vertical direction.

In block 18, the transfer robot moves the lens to a first dipping station. It is noted that the lens may still be at an elevated temperature, such as the mold temperature. A dip tank is preferably heated to a temperature T_{D}, where T_{D} is less than T_{M}. The dip tank preferably includes a primer or a hard coat solution.

The lens is dipped into a liquid at the first station. In one embodiment, this first station includes a primer, preferably with a concentration of less than 10% by volume, and more preferably less than 5% by volume, and even more preferably less than 2% by volume. By the present invention, primer concentrations of about 0.5% by volume may be achieved based on the moisture content of the raw materials used in the molding process. A primer may be employed to provide a layer of material, which assists in transitioning the surface to permit adhesion of an inorganic dipcoat to the organic material of the lens. The primer may include for example, an amino-silane primer. Other primers are also contemplated.

By providing dried thermoplastic to the molding process, outgassing of moisture is reduced or eliminated. Outgassing of moisture can prevent the formation of a primer-to-thermoplastic bond. Advantageously, by reducing the moisture content and reducing outgassing, a hot or higher temperature lens in the process of cooling would still provide sufficient bonding of primer to the lens.

In addition, since pre-drying reduces outgassing, the surface of the lens is more receptive to primer bonding even while the lens is cooling down. This is in contradiction of the prior art, which requires the lens to be cooled to room temperature prior to applying a primer.

One result of the method of the present invention is that the concentration in the primer bath may be reduced to say 2% or less and still have uniform coverage of one or more monolayers of primer. The prior art requires a primer concentration of about 10% or greater by volume. In addition, the primer coating process of the present invention is more efficient requiring less time to primer coat the lens and less time to rinse (to dissolve excess primer) in subsequent rinse steps.

Dipping the lens at the first station is preferably performed without a large amount of splashing, and air bubbles are to be avoided since they may be the source of later problems resulting in the rejection of the lens. The lens is completely submerged in the bath to ensure complete coverage and remains in the bath, for example, for about 30 seconds. The lens preferably has a temperature T_{L}, which is greater than T_{D}, so that intermediate cooling, cleaning, destaticizing and delays associated therewith are avoided. The dip tank, which includes primer, preferably contains below a 2% concentration of primer, and more preferably below a 1% concentration of primer. The dip tank is preferably heated within a range from about 100 degrees F. to about 150 degrees F. (which is the temperature T_{D})

By dipping the lens in a primer or hard coat solution while the lens is still hot, many process steps employed by conventional techniques are eliminated. These steps include but are not limited to cooling the lens, cleaning the lens in detergents and rinse baths, destaticizing steps and related activities. In accordance with the present invention, it has been discovered that by reducing or eliminating moisture in the lens material in advance of primer dipping permits low concentration primer solution usage as well as the ability to dip the lens while it is still hot. Also, heating the dip bath to an elevated temperature (preferably above room temperature) permits a hot lens to be dipped with reduced likelihood of solvent attacks previously feared in conventional techniques. In addition, by providing a “hot dip,” hours of manufacturing delays are avoided and considerable cost savings are realized.

In block 20, the lens is removed from the dip bath. The dipping step may include evening out the thickness of the primer by further dipping the lens in a rinse tank in block 22. The primer and the rinse may include a water-based primer and a water-based rinse, respectively. The lens or lenses are submerged in the rinse bath for a predetermined amount of time so that the rinse bath dissolves away some of the primer to create an even thickness of at least a monolayer of primer over the lens.

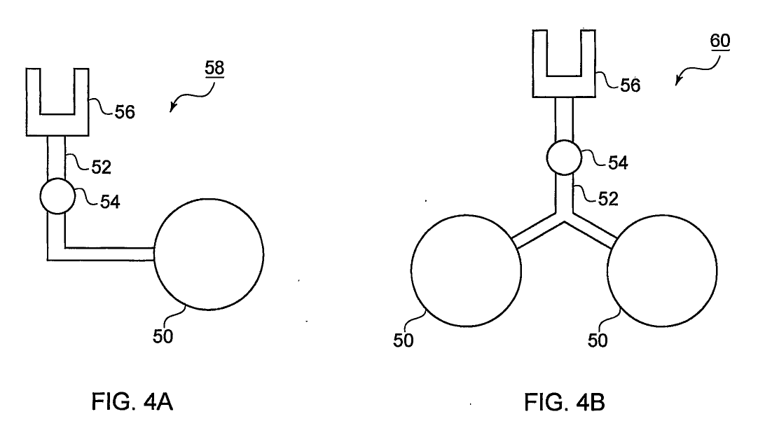

It is noted that the configuration for supporting the lens is one important factor in the yield of the process. Each lens should be supported at its periphery at a location below the horizontal centerline of the lens when held in the dipping position. In one, embodiment, the lens is supported by a stem or gated material, which is integrally formed with the lens and connects to the lens, preferably between a 3 o'clock and a 9 o'clock position. During a dipping process, any structure for holding the lens, which is above the horizontal centerline, could result in liquid collecting on the structure. This collected liquid runs down onto the lens and causes streaks. These streaks may result in the lens being rejected. FIG. 4 illustratively shows illustrative configurations for supporting a lens. FIG. 4 will be described in greater detail below.

The rinse station may include water, an alcohol, a ketone or any other solvent. In a preferred embodiment, the rinse bath includes water, and preferably deionized water. If a primer is not needed then the first station includes this rinse bath and the primer bath is omitted from the process. In one embodiment, which employs primer, the solvent of the bath dissolves the primer to reduce the thickness of the primer. It is preferable that only a thin layer of primer exists on the lens, and more preferably that a monolayer of primer be present. The water in the rinse bath dissolves the primer for a predetermined amount of time to reduce the amount of primer present on the lens, e.g. reduce the primer thickness to about a monolayer. The rinse bath preferably includes the same base solvent of the primer solution. It should be noted that the lens may still be in a state of elevated temperature prior to being immersed in the bath at the second or third station.

When the lens is immersed into the second bath (e.g., a rinse bath), the lens is completely submerged and may be maintained in an immersed state for a predetermined amount or time, e.g., tens of seconds. The rinse bath may be adjusted to optimize the state of the liquid, for example, reduce an agitation frequency of a bath agitator during the immersion.

In block 24, the lens is transferred to a dipcoating station. The dipcoating station may include heat/infrared curable coatings or UV curable coatings. With UV curable coatings, the primer station may be eliminated from the process sequence. The lens is lowered into the bath.

In block 26, after dipcoating, the lens is transferred to a curing line to be pre-cured. In block 28, after pre-curing, the lenses may optionally be inspected. For example, a visual inspection may be performed to determine flaws or cosmetic failures. Then, in block 30, a full cure may be performed. The curing line may include one or more of heating lamps, infrared radiant heaters and/or UV light sources depending on the type of coating employed. The curing is also preferably maintained within the same enclosure as the other process steps.

In block 32, an inspection is performed to look for cosmetic failures, such as streaks, dirt, smudges, lens flaws, etc. Lenses that do not meet the inspection criteria are rejected or set aside for possible rework. Lenses that meet the inspection criteria may be secondarily degated or otherwise prepared for packaging and/or shipment.

Referring to FIGS. 4A and 4B, illustrative lens arrangements are shown which are particularly useful in accordance with the present invention. Each lens 50 connects to a gated stem 52. Stem 52 is preferably formed during the same molding process that forms the lens 50. Stem 52 may include gripping positions 54 and 56, which may be employed to permit lens transfer between stations or robots. Gripping positions 54 and 56 may be employed as locations where a robot or robots grip assemblies 58 and 60, and are particularly useful for transferring lenses between robots. Gripping positions 54 and 56 may include a plurality of elements for securing or interfacing with specific robotic features. Assembly 58 includes a single lens 50 while assembly 60 includes a pair of lenses 50.

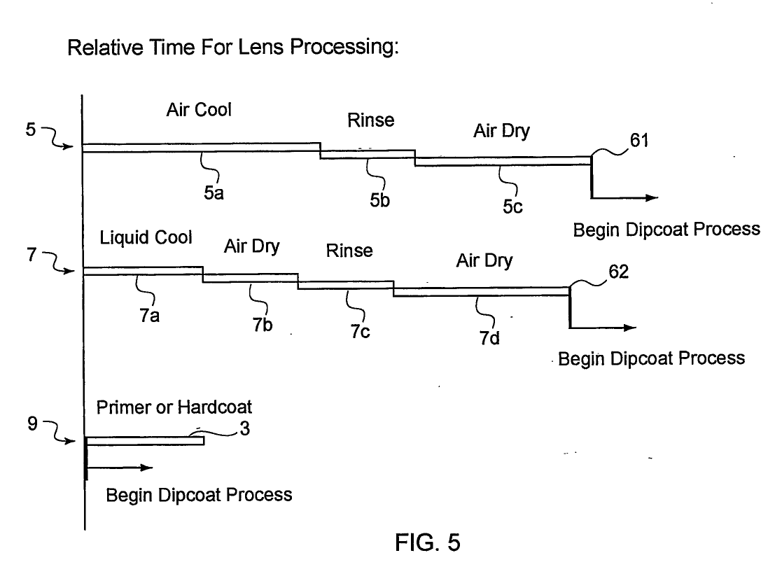

Referring to FIG. 5, a bar chart indicating relative times before lens a dip coating process may be undertaken is illustratively shown. In a first prior art process 5, upon demolding, a lens is air cooled to room temperature (Air Cool 5a). After air cooling, the lens may be dipped in detergent and rinsed (Rinse 5b). The rinse process may include a series of detergent/rinse baths in which the lens is serially dipped. After the cleaning process, the lens is air dried (Air Dry 5c). This process may include exposing the lens to an elevated temperature environment until the lens is completely dried. Once dried, the lens dip coating procedure may begin at point 61.

In a second prior art process 7, upon demolding, the lens is destaticized and cooled in an alcohol bath (Liquid Cool 7a). After reaching, room temperature (bath temperature), the lens is removed from the bath and air-dried (Air Dry 7b). Next, to remove the alcohol residue, the lens is rinsed (Rinse 7c) and air-dried again (Air Dry 7d). The rinse step may include multiple detergent and rinse processes, as stated above. At point 62, the dip coating processing begins.

In accordance with the present invention, dip coating or primer application (i.e., the dip coating process 3) begins immediately after demolding (or perhaps after primary degating) of the lens or lenses. FIG. 5 demonstrates a significant advantage of timesavings due to the hot dip process 9 of the present invention. Advantageously, hours of processing time are reduced or eliminated from the process sequence since air or liquid cool down times are avoided. Furthermore, the present invention eliminates detergent and rinse steps and associated drying times which are required for prior art processes.

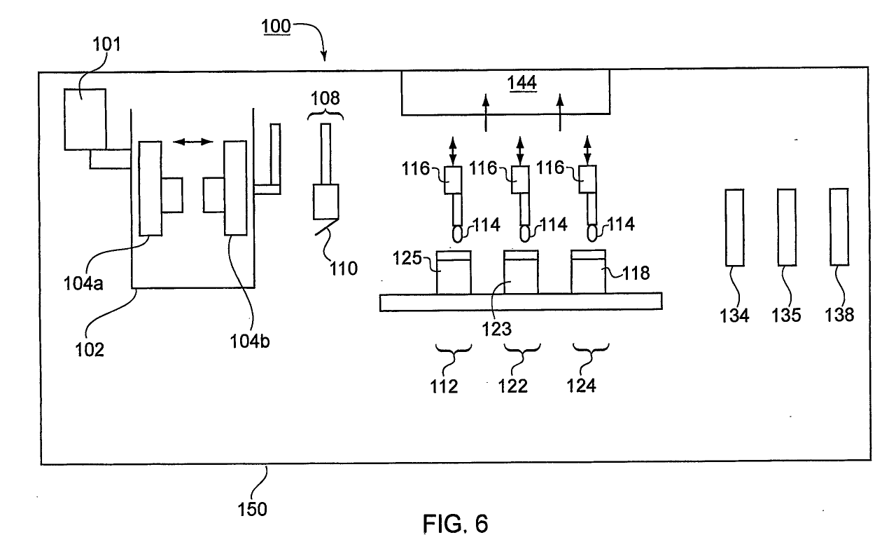

Referring to FIG. 6, an in-line assembly tool 100 is illustratively shown in accordance with one embodiment of the present invention. A drying station 101 may be included to dry out thermoplastic raw materials before molding. Drying station 101 may include a low humidity chamber and/or a temperature controlled chamber for maintaining a dew point temperature at the desired level for a period of time. A molding unit or units 102 may include split-half molds 104a and 104b, which perform, for example, injection or compression molding. The molding cycle includes closing the mold, heating the mold to a given temperature, and injecting molten plastic into the mold. The mold is cooled and the part (e.g., the lens, pair of lenses or multiple pairs of lenses) is extracted from the mold by a take-out robot 106. The plastic part remains hot and is transferred by robot 106 to a degating station 108. A cutter 110, for example, a pneumatic cutter may be employed to remove any sprues or gated material from the lenses.

The takeout robot 106 transfers the lens to a first station 112 for dipping. The first station 112 may include a hard coat station or a primer station. A lens 114 may be transferred to a transfer robot 116 to dip the lens. In an alternate embodiment, the take-out robot 106 and the transfer robot 116 are the same. Robot 106 or 116 positions lens 114 over a bath 118 at station 112. As described above, lens 114 is immersed in the liquid of first station 112 while at an elevated temperature, and then the lens 114 is removed from the bath of first station 112 by robot 116. Depending on the process speed, the shape and volume of the lens and the temperatures of the bath and ambient environment, the lens temperature T_{L} may be maintained at or below the demold temperature T_{M}, but greater than room or ambient temperature.

The lens 114 may still have an elevated temperature before dipping the lens 114 into a second or more baths. In other words, a lens could be hot dipped at a first station, remain hot and be transported and dipped at a second station, and so on. Prior art processes required cooling the lens to room temperature before any dipping coating process steps were begun.

At a second station 122, a bath 123 may include a rinse solvent, such as water, alcohol, a ketone, etc. or a hardcoat liquid. For example, if the first station 112 includes a water-based primer, water is preferably employed in the bath at station 122, more preferably deionized water. In this case, station 122 is a rinse station which assists is dissolving away some of the primer coat applied at station 112. If a primer coat is not needed, station 112 may be eliminated from system 100, and a suitable solvent may be selected for station 122. It is preferable to employ water, however, since alcohols or ketones may be flammable, and may pose health or safety concerns. Additional dipping stations may also be employed and be part of the dip coating process.

It is to be understood that multiple lenses may be processed concurrently. This means that each bath may receive one or more lenses simultaneously to increase throughput. Lenses at each station may be lowered and raised concurrently and then advanced to a next station to provide a constantly progressing manufacturing line.

Next, lenses 114 are transported to a dip coating station 124, submerged in a bath 125 of dip coat or hardcoat material and then removed from bath 125.

Once the dipcoat has been applied, the lens 114 is transported to a pre-cure station 134. Pre-cure station 134 heats the lenses to begin the curing process. Pre-cure station 134 cures the dipcoat to a tacky state so that a visual inspection at station 135 may be performed. The visual inspection eliminates from the manufacturing line lens failures, which can be identified early in the curing process. By inspecting the lenses after a pre-cure, further expense, resources and process time are saved by taking lenses which are recognized early as failures out of the line. Further energy (and curing time) is not expended on these known rejects. The rejected lenses may be salvaged for rework. The visual inspection process may include passing each lens in front of a light to inspect for cosmetic defects, structural defects, and/or contamination due to foreign particles, etc. After the optional inspection process, the lenses are transported to a curing station 138 and passed through an oven or other heat source to provide a full cure of the dipcoat.

After curing, additional inspections may be performed to determine the quality of the lenses output from system 100. These may include automatic (computer-based) inspections or manual inspections. Additionally, secondary degating, packaging or any other post processing steps may be performed.

To increase yield it is advantageous that the process be performed in a single enclosure 150. Enclosure 150 may include a clean room environment or an isolated enclosure. Enclosure 150 is preferably maintained at constant or near-constant conditions. For example, to promote evaporation of water from the lenses after rinse station, low humidity and high temperature are preferred. In one embodiment, relative humidity may be maintained at or below, for example, 15% while the temperature may be maintained at or above, for example, 96 degrees F.

Particulate matter may be filtered from the ambient air by employing an air filtration system 144. Filtration system may include, for example, a HEPA filtration system and more preferably a class 10 or better HEPA filtration system. In this way, air borne particles are removed and the risk of particulate contamination of the dipcoated lenses is reduced.

Having described preferred embodiments for in-line lens manufacturing methods and systems (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A method of decreasing the time between de-molding a lens and initiating a hard coating process, comprising the steps of:
transporting the de-molded lens at a de-mold temperature T_{M} away from a mold;
maintaining a dip tank to a temperature T_{D}, where T_{D} is less than T_{M}, wherein the dip tank includes a liquid including one of a primer and a hard coat solution; and
dipping the lens into the dip tank wherein the lens has a temperature T_{L} greater than T_{D}, so that intermediate cooling, cleaning, destaticizing and delays associated therewith are avoided.

2. The method of claim 1, further comprising transporting the de-molded lens within a reduced humidity environment.

3. The method of claim 2, wherein the reduced humidity environment is heated.

4. The method of claim 2, wherein the reduced humidity environment is heated to a temperature within a range from about 90 degrees F. to about 110 degrees F.

5. The method of claim 2, wherein the reduced humidity environment comprises a high efficiency particulate arresting (HEPA) filtered environment.

6. The method of claim 1, wherein during said transporting step the method further comprises the following step:
cutting a cold-runner disposed between two or more lenses.

7. The method of claim 6, wherein the cutting step occurs within a high efficiency particulate arresting (HEPA) air curtain.

8. The method of claim 6, wherein the cutting step occurs within a high efficiency particulate arresting (HEPA) downdraft airflow.

9. The method of claim 1, further comprising the step of drying raw material, used for forming the lens, before introducing the raw material into the mold.

10. The method of claim 9, wherein the drying step includes maintaining the raw material in an ambient environment having a negative dew point temperature.

11. The method of claim 10, wherein the maintaining the raw material step includes maintaining the raw material in an ambient environment having a dew point temperature of −40 F for between about 2 hours and about 4 hours.

12. The method of claim 9, wherein the dip tank contains below a 2% concentration of primer.

13. The method of claim 9, wherein the dip tank contains below a 1% concentration of primer.

14. The method of claim 1, wherein the dip tank is heated within a range from about 100 degrees F. to about 150 degrees F.

15. The method of claim 1, wherein the dipping step includes a primer dip and the method additionally includes the step of:
evening out the thickness of the primer by further dipping the lens in a rinse tank.

16. The method of claim 15, wherein the primer and the rinse comprise a water-based primer and a water-based rinse, respectively.

17. A method of decreasing the time for dipcoating a lens, comprising the steps of:
drying thermoplastic raw material in advance of molding an article;
molding the article; and
dipping the article while the article is at a temperature greater than the ambient temperature in a dip tank including a primer solution, wherein the primer in the solution has a concentration of less than 10% by volume.

18. The method of claim 17, wherein the step of drying includes maintaining the raw material in an ambient environment having a negative dew point temperature.

19. The method of claim 18, wherein the maintaining step includes maintaining the raw material in an ambient environment having a dew point temperature of −40 F for between about 2 hours and about 4 hours.

20. The method of claim 17, wherein the method is conducted in a heated reduced humidity environment.

21. The method of claim 17, further comprising the step of transporting the article between a mold and the dipping tank.

22. The method of claim 21, wherein article includes a lens and the step of transporting further comprises cutting a cold-runner disposed on the article.

23. The method of claim 17, wherein the dip tank contains below a 2% concentration of primer.

24. The method of claim 17, wherein the dip tank contains below a 1% concentration of primer.

25. The method of claim 17, wherein the dipping step includes the step of:
evening out the thickness of the primer by further dipping the lens in a rinse tank.

26. The method of claim 25, wherein the primer and the rinse comprise a water-based primer and a water-based rinse, respectively.
